(19) United States
(12) Patent Application Publication
(10) Pub. No.: US 2012/0205531 A1
(43) Pub. Date: Aug. 16, 2012

(54) Quantitation Precision for Isobarically Labeled Peptides Using Charge State Targeted Dissociation

(76) Inventor: Vladimir ZABROUSKOV, Belmont, CA (US)

(21) Appl. No.: 13/025,029

(22) Filed: Feb. 10, 2011

(51) Int. Cl. B01D 59/44

(52) U.S. Cl. 250/282

(57) ABSTRACT

The instrument initially assesses the purity of a given candidate parent. If the candidate parent is contaminated with an isobaric signal(s), it promptly focuses on the alternative charge state(s) for the same neutral mass. Specifically for every peptide mass there are almost universally several charge states (usually 1-4 for tryptic peptides) present in the ESI spectrum. An optional step may be used for more complex situations where alternative (lower) charge states are not evident in the spectrum. In this case, proton transfer is performed on a higher charge state. Next, if the reduced ion parent is isobarically pure, a higher energy collisionally activated dissociation is performed on the reduced ion parent. Alternatively, a dedicated targeted isolation can be performed for low abundant precursors at calculated m/z if they fall below LOD of the analyzer full scan.

### BACKGROUND

The amino acid sequence of proteins links proteins and their coding genes via the genetic code. Molecular analysis, e.g. the identification of proteins and determination of their chemical structures, provides a window into complex cellular regulatory networks. Ion trap mass spectrometers perform the molecular analysis by isolating a group of compounds from a set of samples. The samples may have underwent an extraction techniques, e.g. proteins from tissues, cell lysates, or fluids followed by proteolytic digestion of those proteins into peptides. The mass spectrometers may be coupled with additional separations, e.g. electrophoretic or chromatographic. Thus, mass spectral instruments can analyze tens of thousands of molecular species via tandem mass spectrometry.

Quantitative analysis in chemistry determines the absolute or relative abundance of one, several, or all particular substances(s) present in a sample. For mass spectrometric quantitation, a mass spectrometer capable of MS/MS fragmentation is used. Among the labeling techniques, isobaric tags (iTRAQ or TMT) for relative quantitation of peptides is widely used in combination with post-acquisition software to provide the relative abundance of peptides in the mixture. However, when a peptide precursor is selected, there are often interfering species with similar mass-to-charge ratios that are co-isolated and subjected to activation. These species are often other isobarically tagged peptides with different relative quantitation, which can introduce error into the quantitative measurement of the peptide of interest.

### SUMMARY

The instrument initially assesses the purity of a given candidate parent. If the candidate parent is contaminated with an isobaric signal(s), it promptly focuses on the alternative charge state(s) for the same neutral mass. Specifically for every peptide mass there are almost universally several charge states (usually 1-4 for tryptic peptides) present in the Electro-Spray Ionization (ESI) spectrum.

An optional experimental step may be used for more complex situations where alternative (lower) charge states are not evident in the spectrum. In this case, proton transfer is performed on a higher charge state. Next, if the reduced ion parent is isobarically pure (the interference is below set threshold), the reduced ion parent is subjected to higher energy collisional dissociation (HCD). Alternatively, a dedicated targeted isolation can be performed for low abundant precursors at calculated m/z if they fall below LOD of the analyzer full scan.

### BRIEF DESCRIPTION OF THE DRAWINGS

FIG. 1 is block diagram of a tandem mass spectrometer.

FIG. 2 is block diagram for the controller shown in FIG. 1.

FIG. 3 is a process flowchart for the dynamic purity assessor shown in FIG. 2 according to the invention.

### DETAILED DESCRIPTION

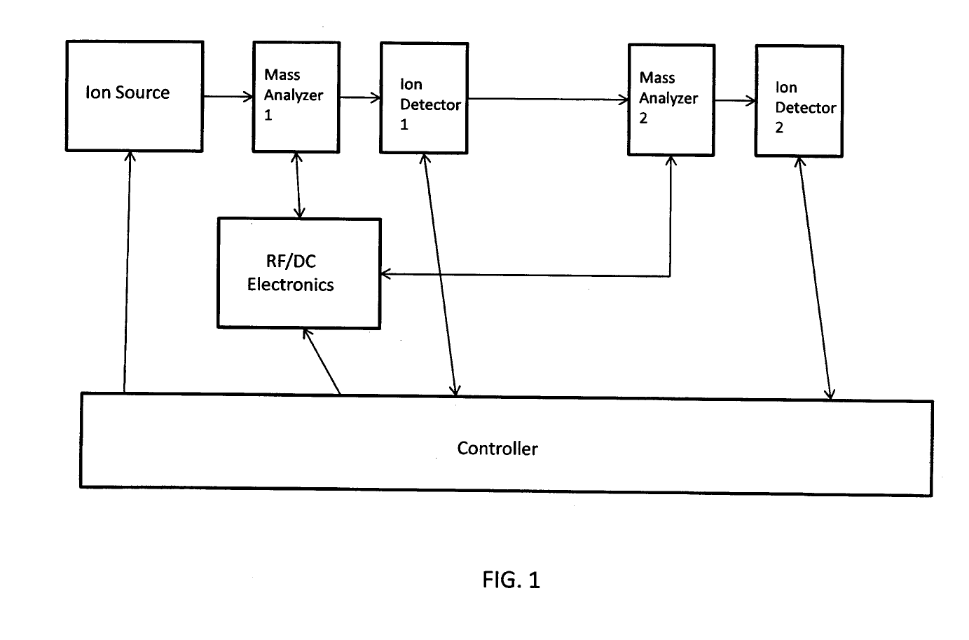

FIG. 1 is a block diagram of a tandem mass spectrometer 10. Within a high vacuum environment, there is a first and a second mass analyzer (MS1/MS2) 12, 14. An activation or reaction stage 16 interposes the mass analyzers (MS1/MS2) 12, 14. A detector 18 connects to the second mass analyzer (MS2) 14. An ion source 20 introduces sample into the first mass analyzer (MS1) 22. A controller 24, e.g. computer is in bidirectional communication with the ion source 20, the first and the second mass analyzers (MS1/MS2) 12, 14, the activation/reaction stage 16, and the detector 18.

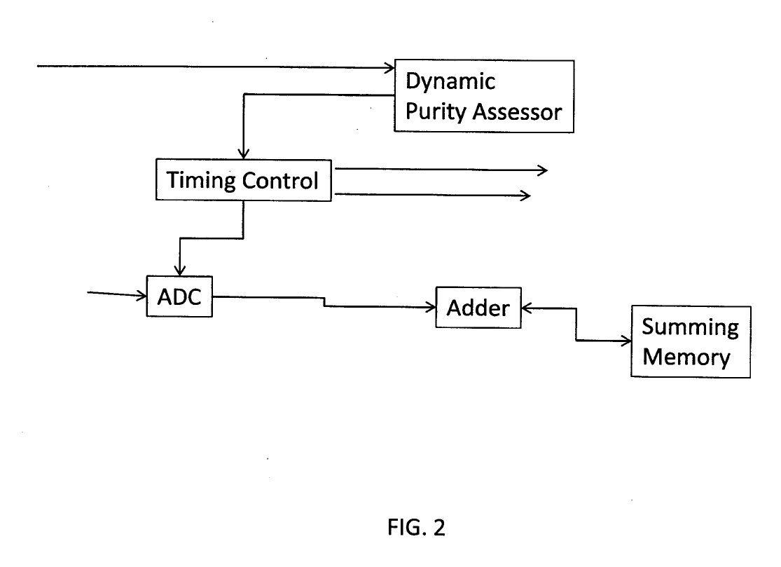

The controller 24, shown in FIG. 1, controls the analyses performed by the mass spectrometer 10 according to the flowchart shown in FIG. 2. An analog-digital converter (ADC) receives the signal from the detector and a timing controller. An adder receives the output of the ADC and bidirectionally connects to summing memory. The timing control receives spectral data from the dynamic purity assessor and generates control signals for the MS1 and the MS2 scans.

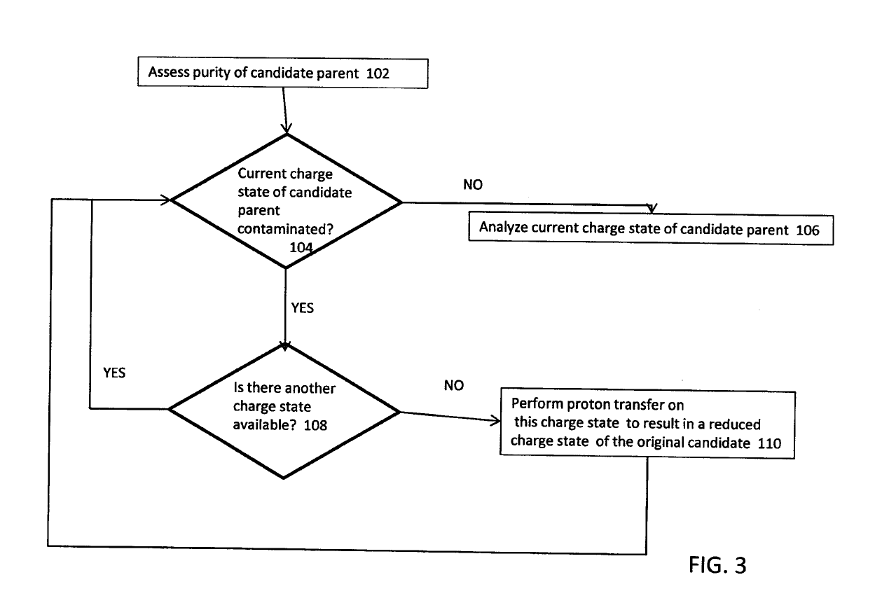

FIG. 3 illustrates the dynamic purity assessor shown in FIG. 2. In step 102, the instrument assesses the purity of a given candidate parent. The purity of the candidate parent is dynamically evaluated. One technique is the XTRACT application available from Thermo Fisher Scientific. In this illustrative technique, the isotropically resolved spectra is deconvolved. All unknown charge states are presented as possible states. The relation between different states is formalized as the probability of belonging to the same mass. Thus, all charge states belonging to the same mass present a charge state chain.

In step 104, it is determined if the current charge state of the candidate parent is contaminated.

If the given candidate parent is pure, in step 106, the current charge state is evaluated. The inventive method takes advantage of the ESI spectra where vast majority of the precursors are present in several charge states. Specifically for every peptide mass there are almost universally several charge states (usually 1-4 for tryptic peptides) present in the ESI spectrum. Analysis techniques include dissociation using higher energy collisional dissociation (HCD), etc. Alternatively, a dedicated targeted isolation can be performed for low abundant precursors at calculated m/z if they fall below LOD of the analyzer full scan.

If the given candidate parent is contaminated, in step 108, it is determined if there is another charge state for the neutral mass. If yes, return to step 104.

If no, step 110, a proton transfer on a higher charge state may be performed on this charge state to result in a reduced charge state of the original candidate before returning to step 104. Proton transfer is useful in complex situations where alternative (lower) charge states are not evident in the spectrum.

Steps 104 through 110 are evaluated until the available charge states are exhausted.

1. A mass spectrometry method comprising:
performing a mass spectrometry scan;
for a precursor ion having n charge states, where n is an integer between 1 and N, where N is an integer greater than 1, assessing the isotopic purity at the nth charge state;
when the isotopic purity is below a predefined threshold, assessing the isotopic purity at the n+1th charge state; and
when the isotopic purity is above the predefined threshold, performing the next mass spectrometry scan.

2. The mass spectrometry method, as in claim 1, further comprising when the isotopic purity is below the predefined threshold and the n charge state has been assessed, performing a proton transfer on a higher charge state generating a reduced ion parent.

3. The mass spectrometry method, as in claim 2, performing higher energy collisionally activated dissociation of the reduced ion parent

4. The mass spectrometry method, as in claim 1, further comprising when the isotopic purity is below the predefined threshold and the n charge state has been assessed, performing a targeted isolation for low abundant precursors at a calculated m/z.
